(19) United States
(12) Patent Application Publication
(10) Pub. No.: US 2011/0041367 A1
(43) Pub. Date: Feb. 24, 2011

(54) ANIMAL TAGS AND METHOD OF MANUFACTURE

(76) Inventors: Roy Victor Bladen, Auckland (NZ); Michael Stuart Gardner, Auckland (NZ); Todd Michael Howell, Auckland (NZ)

Correspondence Address: HENRICKS SLAVIN AND HOLMES LLP;SUITE 200, 840 APOLLO STREET, EL SEGUNDO, CA, 90245, US

(21) Appl. No.: 12/990,505

(22) PCT Filed: Apr. 27, 2009
(86) PCT No.: PCT/NZ2009/000062

§ 371 Date: Oct. 31, 2010

(30) Foreign Application Priority Data
May 2, 2008 (NZ) 567985

(51) Int. Cl. A01K 11/00; G09F 3/06; B23P 17/04

(52) U.S. Cl. 40/300; 29/428

(57) ABSTRACT

An animal tag includes a flag (11) of substantially flexible material about which is secured a substantially rigid assembly (14) including a flanged member (15), a cap (17), and an insert (18) which assists the retention of the head of a male tag (not shown) within the cap (17). In another embodiment the tag is formed as a strip of indeterminate length of the flexible material. The aperture (19) may also be omitted and formed during use of the tag, by the head of the male tag. The substantially rigid assembly (14) may provide part of a male tag or part of a female tag as shown.

### FIELD OF THE INVENTION

The present invention relates to improvements in and relating to tags and their method of manufacture. For the sake of simplicity reference will be made throughout to “animal tags” but it will be apparent to those skilled in the relevant areas of technology that the present application would have significance throughout the field of tags of all types and for all uses including luggage tags, medical tags, horticultural tags and the like. For the purposes of this specification the term “animal tag” is intended to encompass all types of tags.

### BACKGROUND OF THE INVENTION

Ear tags are used internationally in order to uniquely identify animals. In order to minimise the risk of tags being torn away from the animal, or being snapped off, the use of flexible material for the tags has major benefits.

To this end various proposals have been put forward including those in which a flexible flag, on which the appropriate indicia may be printed, is provided with an appropriate male or female tag portion which may be integrally formed, (see for example UK patent 2,160,153 (Dalton Supplies)), or provided as a separate integer, (see for example U.S. Pat. No. 5,725,261 (Rahn)).

To date such previous proposals have suffered from various disadvantages, both in the tag structure, and in their manufacture. In the former regard, where there is a discrete male or female tag portion, and there is no permanent joint between the tag parts, there is a risk that the tag can be taken apart so that the identity of the animal can be lost. Also, where a rigid male or female tag portion, for example, is joined to a semi-flexible flag, a dynamic loading can be created at their interconnection as the tag is flexed by the animal, resulting in the tag's breakage. In the latter regard, particularly when the tag is formed as an integral structure, the tooling can be extremely expensive due to its complexity, and typically, also due to restrictions on the types of plastics which are able to be used.

In another previous proposal a panel of soft material, such as a soft grade of polyurethane, is over-moulded so as to encapsulate a rigid boss of a material such as hard grade polyurethane, (see for example NZ patent 504742 (Allflex New Zealand). Such a proposal, and other proposals, require the panel to be above a suitable thickness and hence flexibility is compromised. It also requires specific and complex tooling for the moulding of the panel. Mechanical limitations of present tooling also limit the solutions available from tag designs. Also problems such as tag curling are caused post-manufacture due to mould stresses.

### OBJECTS OF THE INVENTION

It is therefore an object of the present invention, at least according to one embodiment thereof, to provide an animal tag which overcomes or at least alleviates problems in animal tags at present or at least which provides the public with a useful choice.

It is an object of another embodiment of the present invention to provide a method of manufacture of an animal tag which again overcomes or alleviates problems in animal tag manufacture at present or at least provides the public with a useful choice.

Further objects of the invention, which are all to be considered disjunctively, will become apparent from the following description which is given by way of example of possible embodiments of the invention.

### SUMMARY OF THE INVENTION

According to one aspect of the present invention there is provided an animal tag including a flag portion of a substantially flexible material in which secured about a portion of the substantially flexible material is a substantially rigid portion which provides, in use, a female or male tag member.

According to a second aspect of the present invention there is provided a method of manufacture of an animal tag having a flag portion of a substantially flexible material in which a substantially rigid portion is secured about a portion of the substantially flexible material to provide a female or male tag member.

Preferably the flag portion is provided as a strip of indeterminate length which is able to be separated into a plurality of individual flag portions.

Preferably the rigid portion is welded, over moulded or riveted about the flag portion.

Preferably the rigid portion has at least a first and a second part which are secured or securable on opposite sides of the substantially flexible material.

Possibly the rigid portion may include an identification means.

According to a further aspect of the present invention there is provided an animal tag and/or a method of manufacture of an animal tag, substantially as herein described with reference to any one of the embodiments shown in the accompanying drawings.

Further aspects of this invention may be apparent from the following description given by way of example only and with reference to the accompanying drawings.

### BRIEF DESCRIPTION OF THE DRAWINGS

FIG. 1: Show respectively top, side, underneath, end, side perspective, underneath perspective and exploded views of a tag according to one possible embodiment of the invention;

FIG. 2: Show respectively, top, side-section, underneath and part exploded views of a tag according to a further possible embodiment of the invention;

FIG. 3: Show respectively, top, side-section, underneath and part exploded views of a tag according to a further possible embodiment of the invention;

FIG. 4: Show respectively, top and exploded views of a tag according to a further possible embodiment of the invention;

FIG. 5: Show respectively, top, side-section and underneath views of a tag according to a still further possible embodiment of the invention;

FIG. 6: Show respectively, top, sectional and end views of a tag according to a further possible embodiment of the invention;

FIG. 7: Show the tag of FIG. 6 including a male tag member;

FIG. 8: Show respectively, cross-sectional, underneath-exploded and side-exploded views of a further embodiment of the invention;

FIG. 9: Show respectively, side perspective, underneath and underneath-exploded views of a still further embodiment of the invention;

FIG. 10: Show respectively, top perspective, underneath perspective, end, top, side and underneath views of a further possible embodiment of the invention;

FIG. 11: Show respectively, top perspective, underneath perspective, underneath, cross-sectional, end and top views of a still further possible embodiment of the invention;

FIG. 12: Show respectively, top perspective, underneath perspective, underneath, side, top and cross-sectional views of a further possible embodiment of the invention; and

FIG. 13; Shows respectively exploded, top, underneath and cross-sectional views of a further possible embodiment of the invention.

### DESCRIPTION OF POSSIBLE EMBODIMENTS OF THE INVENTION

The present invention broadly provides a tag and particularly an animal tag which in its structure and in its manufacture may provide the benefits of a substantially flexible flag portion on which suitable indicia identifying the animal would usually be accommodated and a permanently secured substantially rigid portion which can function as a male or female tag member. In doing so the present invention seeks to achieve a simpler and less expensive manufacture of the tag and overcome or at least alleviate the problems with existing tags or their method of manufacture as outlined previously.

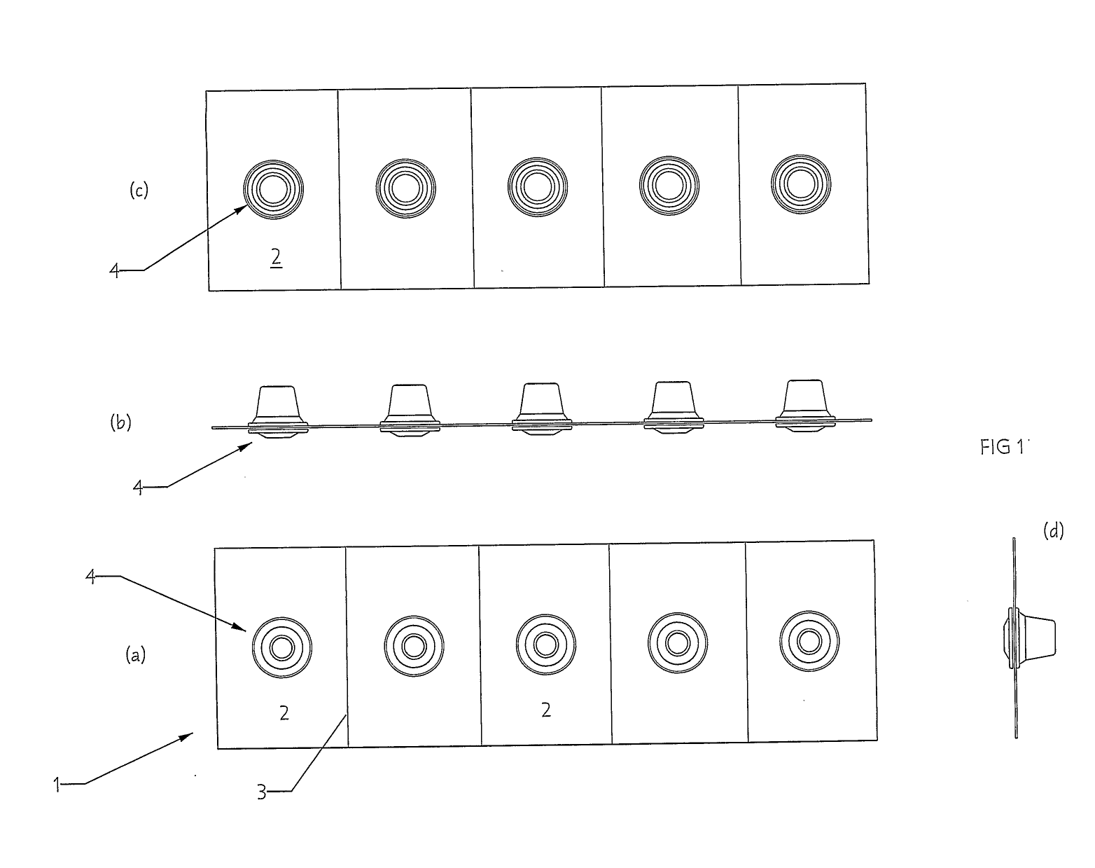

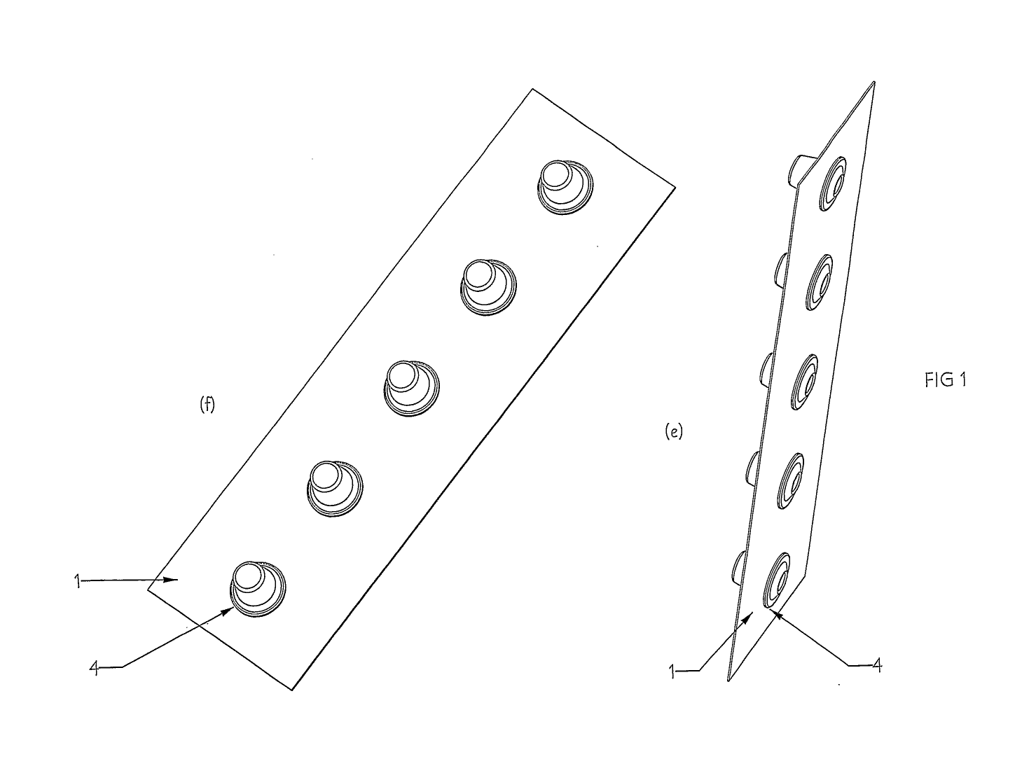

Referring therefore to FIG. 1 of the accompanying drawings, one possible embodiment of the invention is shown which is in the form of a strip 1 of separable substantially flexible portions 2 which may for example have a line of weakness or perforations 3 to facilitate that separation as they are required for individual use. The portions 2 may be of any suitable flexible material but in particular a suitable resilient plastics material such as polyurethane.

As shown, a separate substantially rigid component, referenced generally by arrow 4, is provided for each of the flexible portions 2 and which has become integrated with the flexible portions 2. As seen particularly in FIG. 1 (g) the substantially rigid components 4 may in this embodiment include a flanged member 5 with an aperture 6 which will be secured on one side of each flexible portion 2 and a cap member 7 and a washer-like member or insert 8 which are securable on the opposite side of each flexible portion 2 and about an aperture 9 which in this embodiment is shown provided for each flexible portion 2.

Depending particularly on the material (s) utilised for the member 4, its components may be secured about each of the flexible portions 2 by any suitable means such as welding, over moulding, riveting or the like so as to become securely, permanently, and intimately part of the flexible portion 2 and in this embodiment positioned substantially along a central longitudinal axis of the strip 1.

It will be appreciated that in the manufacture of the strip 1, simple and inexpensive tooling will be involved and then straight forward tooling can be provided to enable the securement of the individual components 4 in place and about the flexible portions 2 at an appropriate time e.g. this may be done at the printing stage.

It is mentioned that although in this embodiment the strip 1 is provided with sequentially spaced apertures 9, in an alternative embodiment those apertures 9 may be omitted and the aperture would be created in use by the insertion of the male tag member. The rigid or at least substantially rigid washer or insert 8, when provided, will assist the retention of the head of the male tag (not shown) within the cap member 7 so as not to rely on the rigidity of the cap member 7 for this purpose.

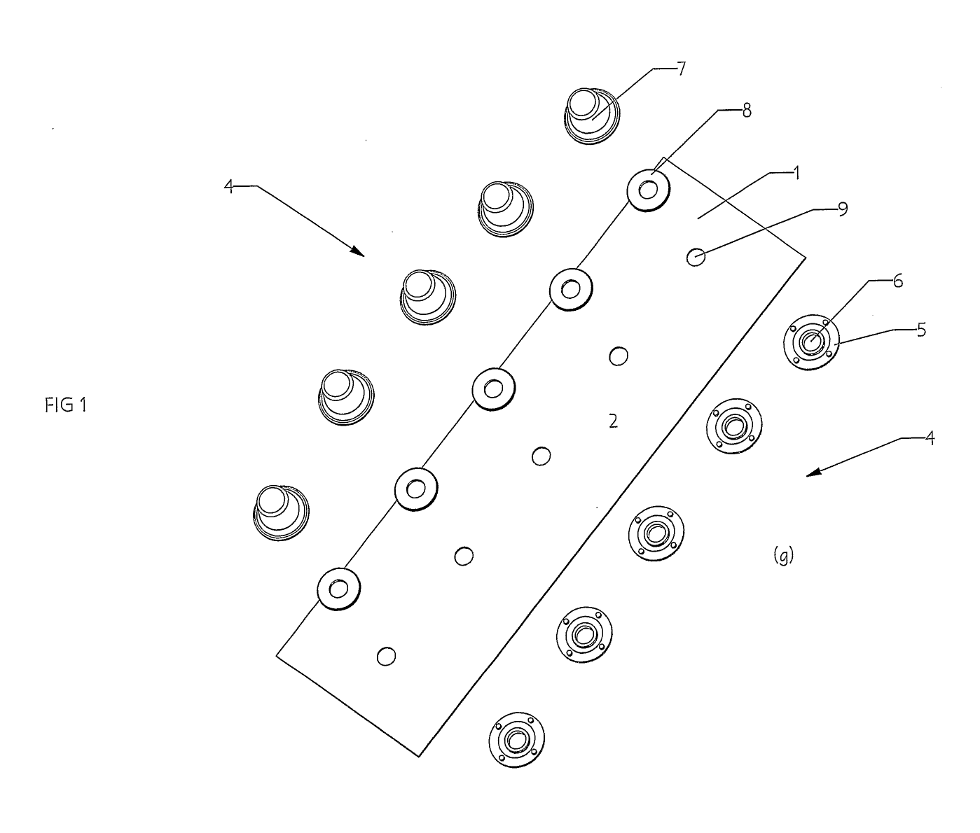

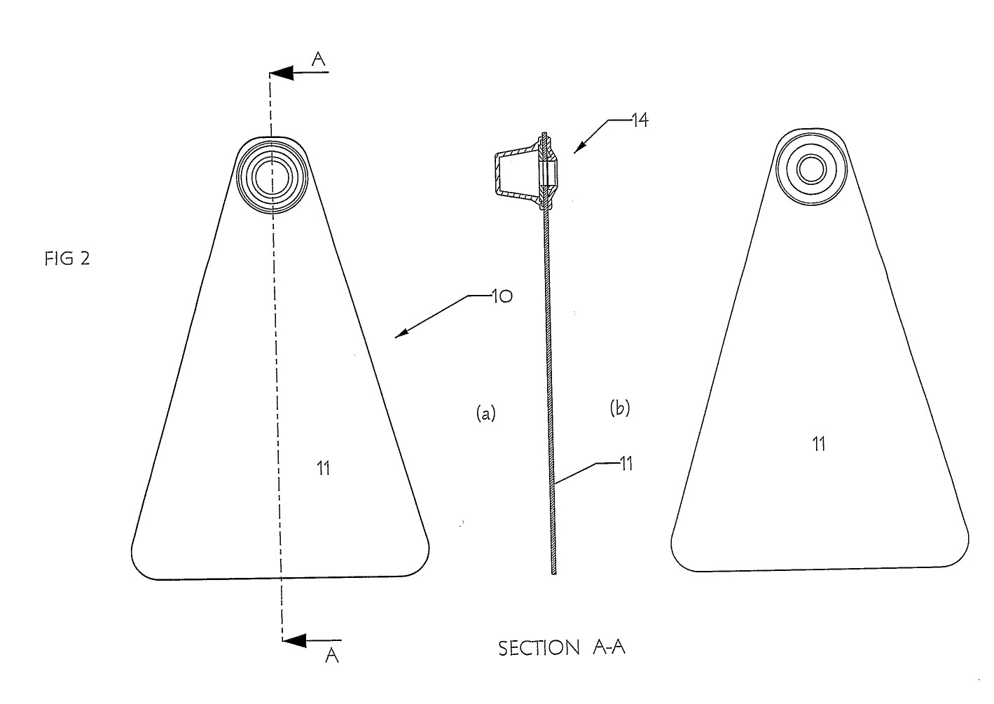

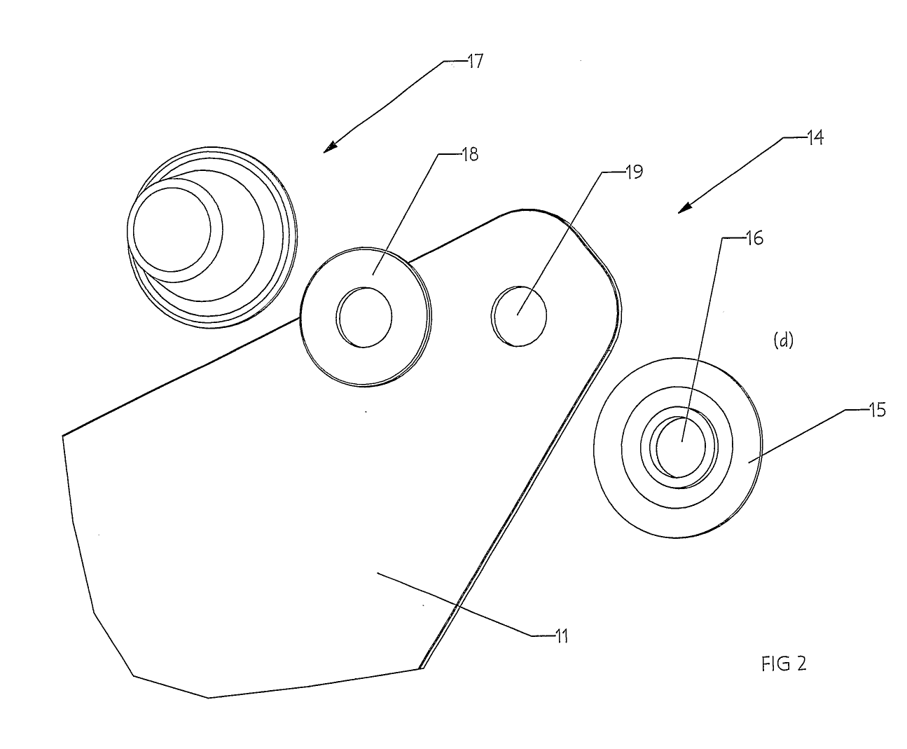

Referring then to FIG. 2, in a further possible embodiment of the invention an individual tag 10 is shown including a flag portion 11 of a substantially flexible material. Secured thereabout, and towards one end thereof, is a substantially rigid portion 14 including a flanged member 15 with an aperture 16 and a cap member 17 with a washer-like member or insert 18. This rigid portion again can be secured in any suitable manner, on either side of the material of the flag 11, about an aperture 19 provided for in this embodiment, towards an apex of the flag portion 11. Again the provision of the washer or insert 18 can assist the retention of the head of the male tag (not shown).

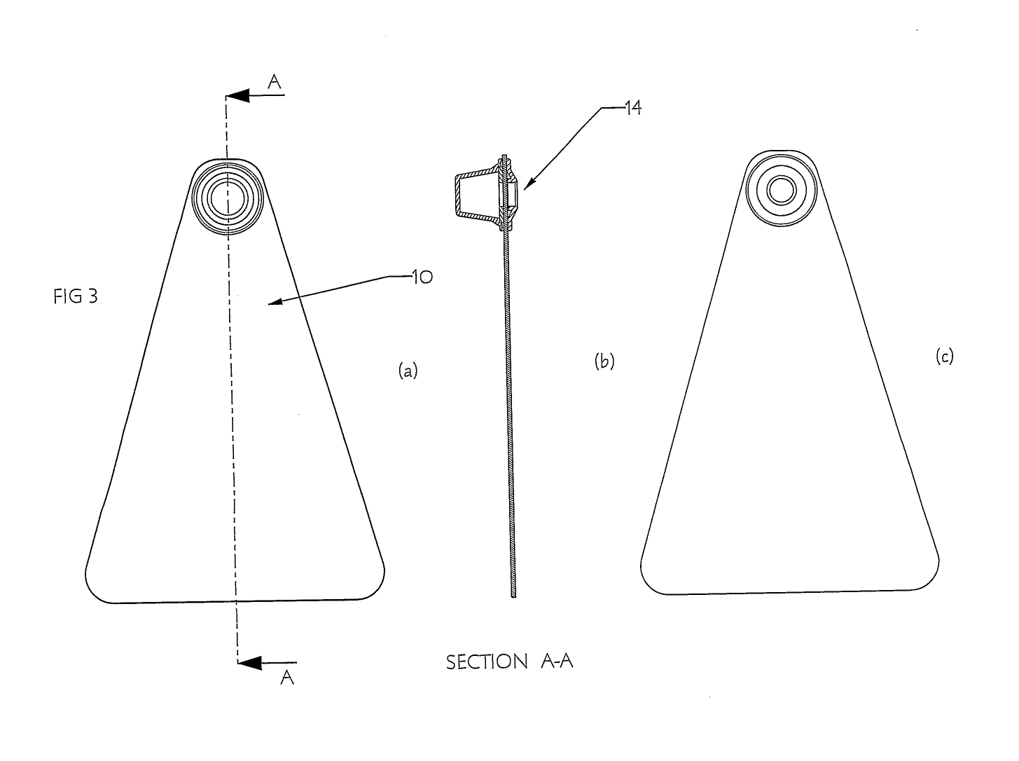

Referring then to FIG. 3 it is seen, particularly in FIG. 3d, that in this embodiment the aperture 19 of the embodiment of FIG. 2 is omitted so that the aperture would be created by a male tag member during use.

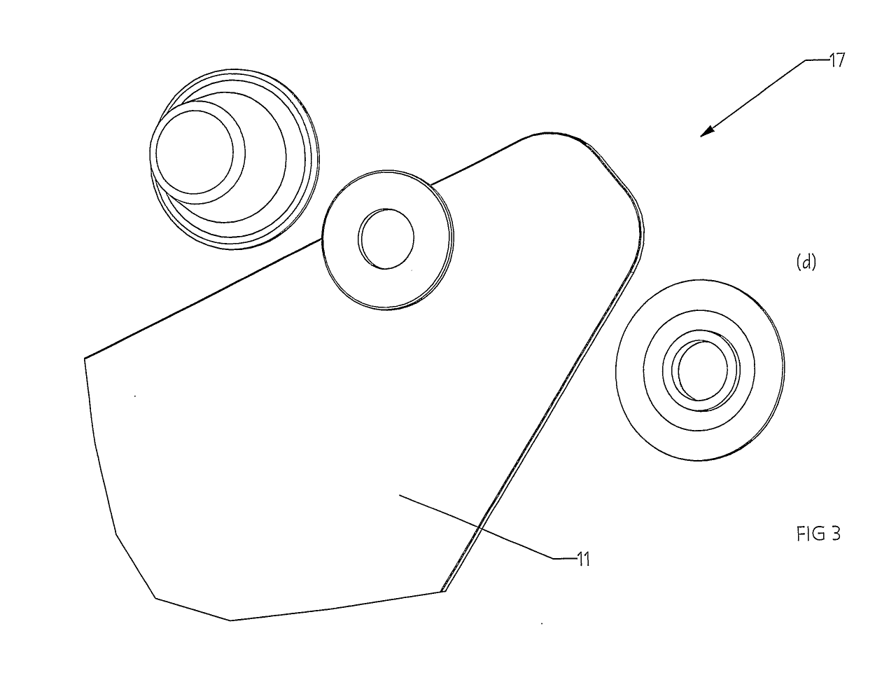

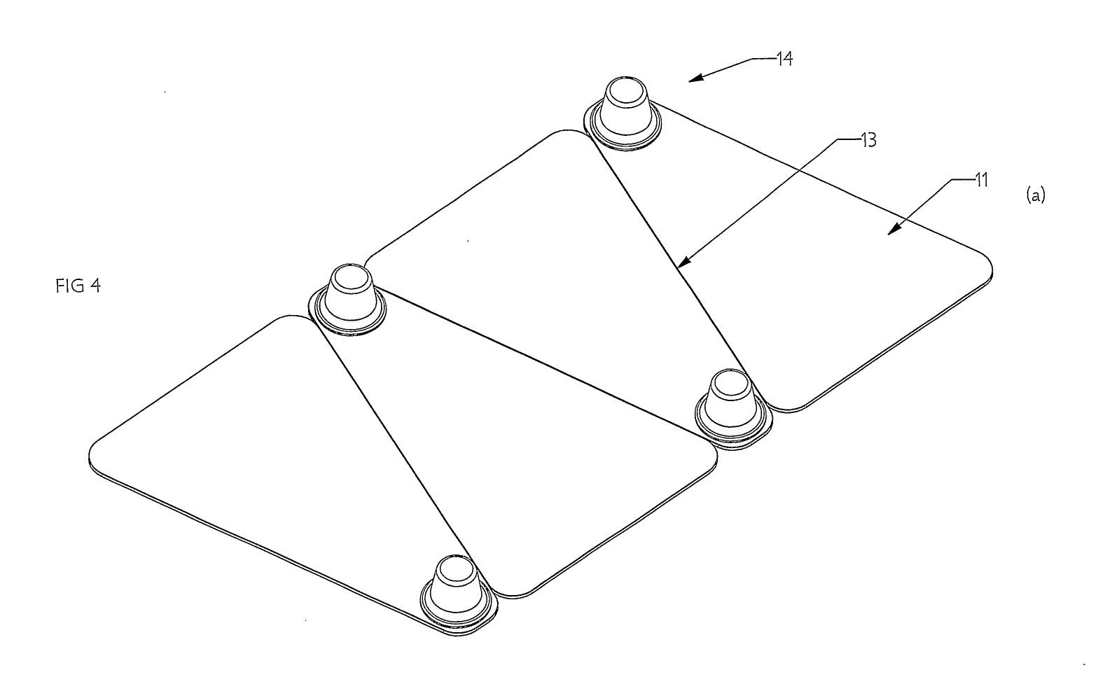

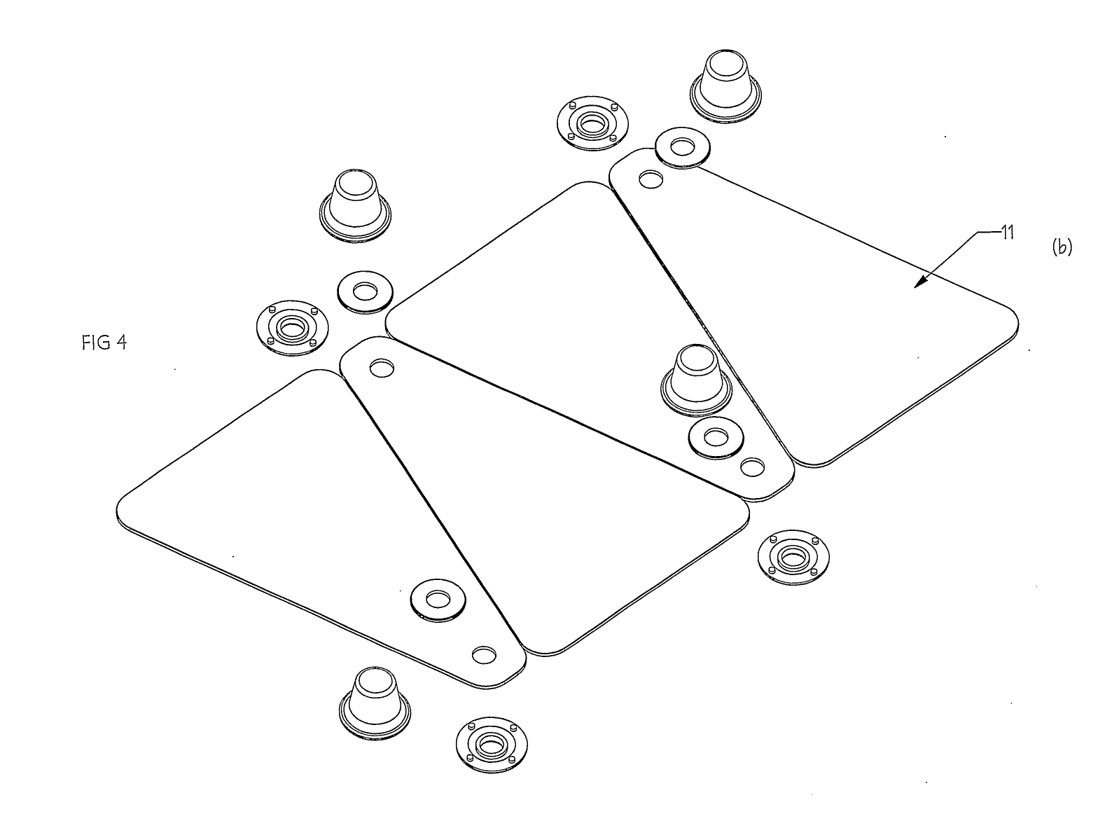

In FIG. 4 the flag portions 11 of a substantially flexible material are shown provided in the form of an elongate strip of indeterminate length, suitably with lines of weakness or perforations 13, and to which individual, substantially rigid, components 14 may be secured thereabout in any suitable manner.

Referring then to FIG. 5, the flag portion 20 of substantially flexible material is shown with substantially rigid component 24 having a flanged member 25 and a cap member 27 which are secured thereabout on either side of the flag portion 20 and, in this example, without penetration of the material of flag portion 20 (see FIG. 5b) until this is effected by the head of the male tag (not shown).

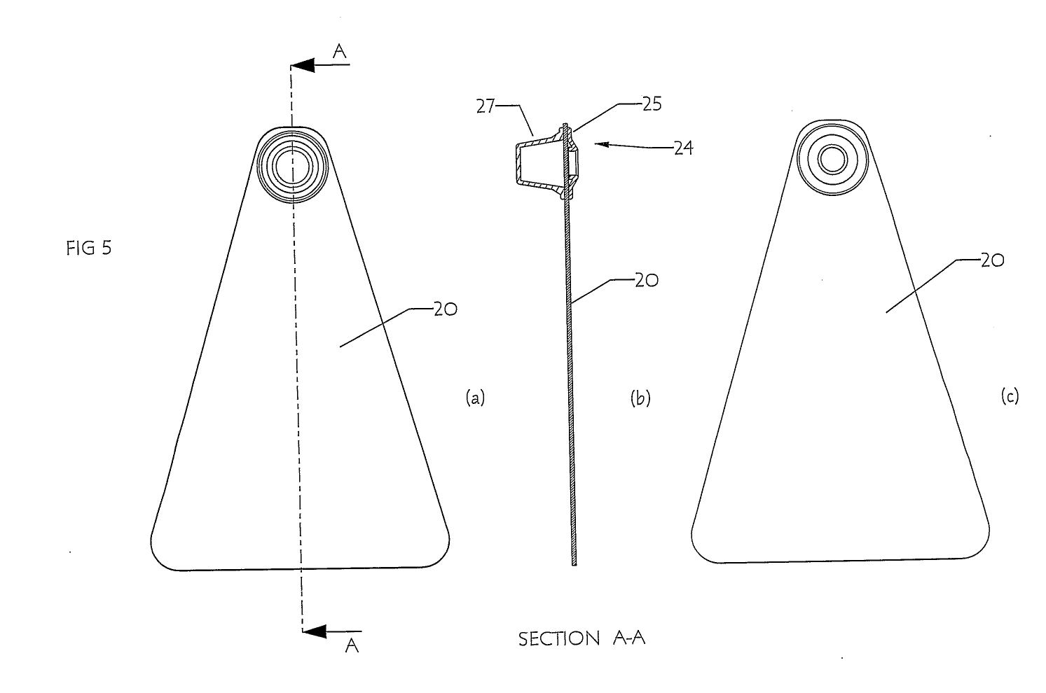

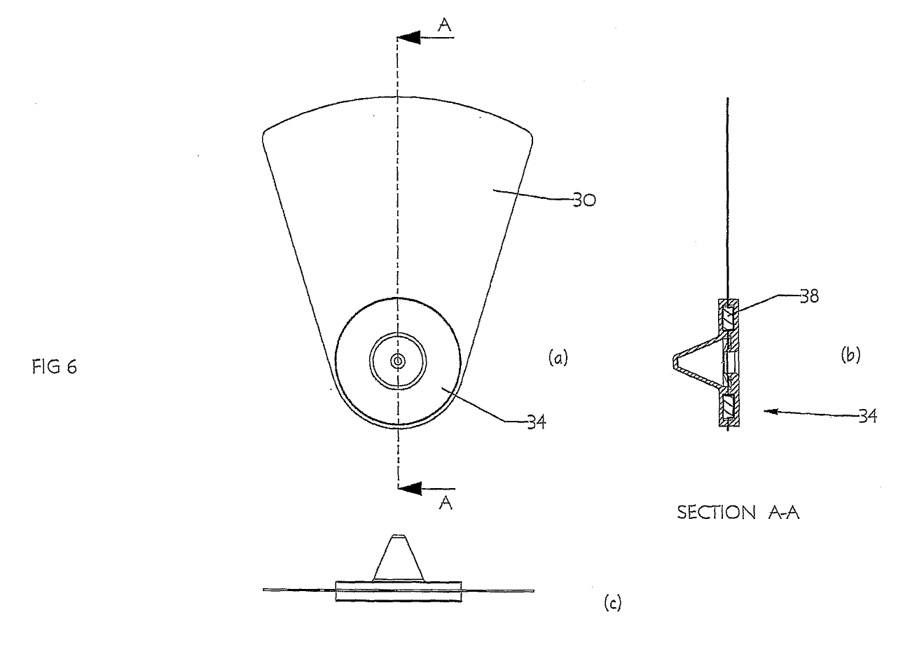

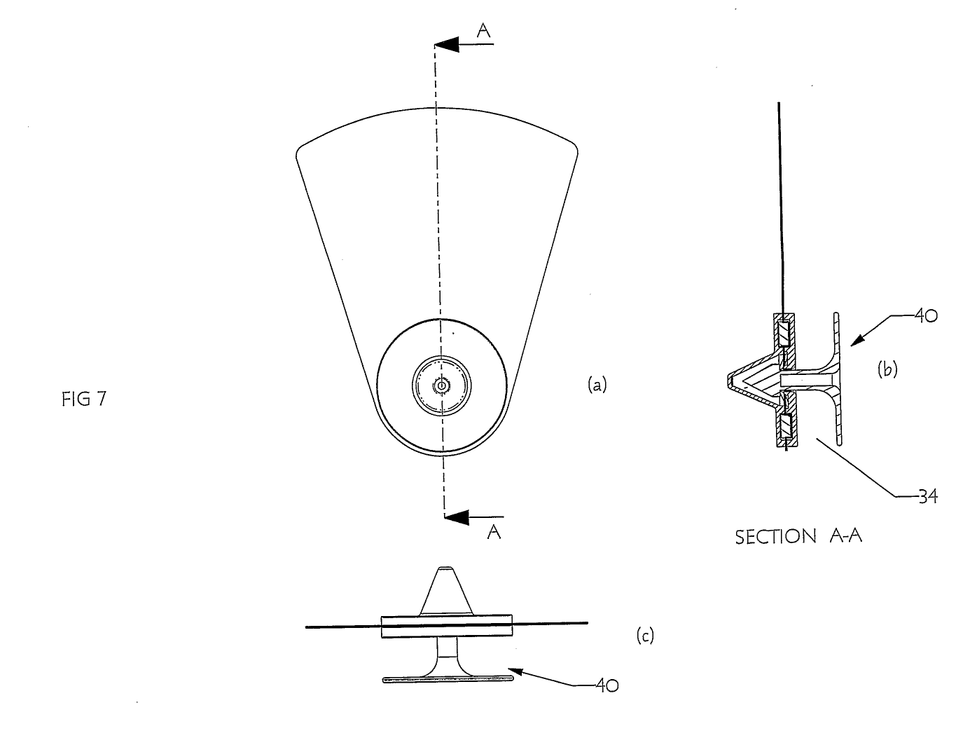

Referring then to FIG. 6, the flag portion 30 of a substantially flexible material includes secured thereabout and integral therewith a substantially rigid component 34, shown including an identification device such as an RFID device 38 or the like such as a transponder. In FIG. 7, a male tag member 40 is shown in position engaged with the member 34. The embodiment of FIGS. 6 and 7 does not necessarily include a washer or insert between the component 34 and the flag 30 but one may be provided, as shown in outline in FIG. 7 (a), to assist the retention of the male tag 40 in the cap.

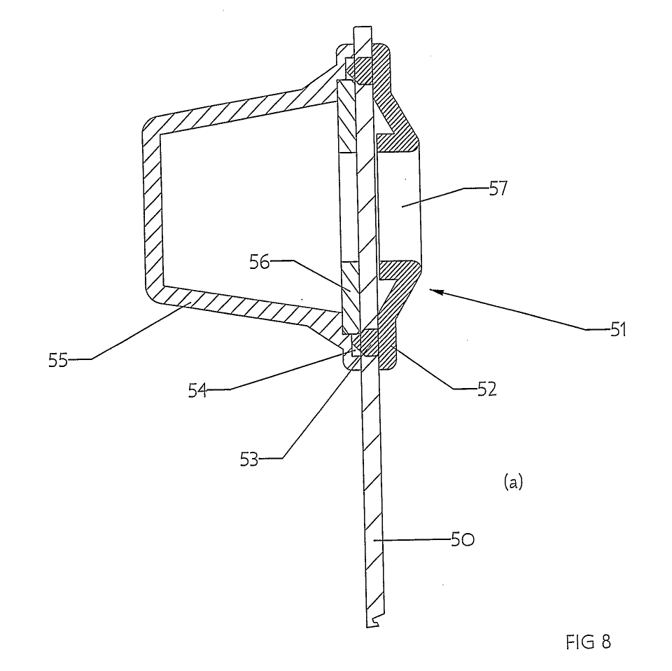

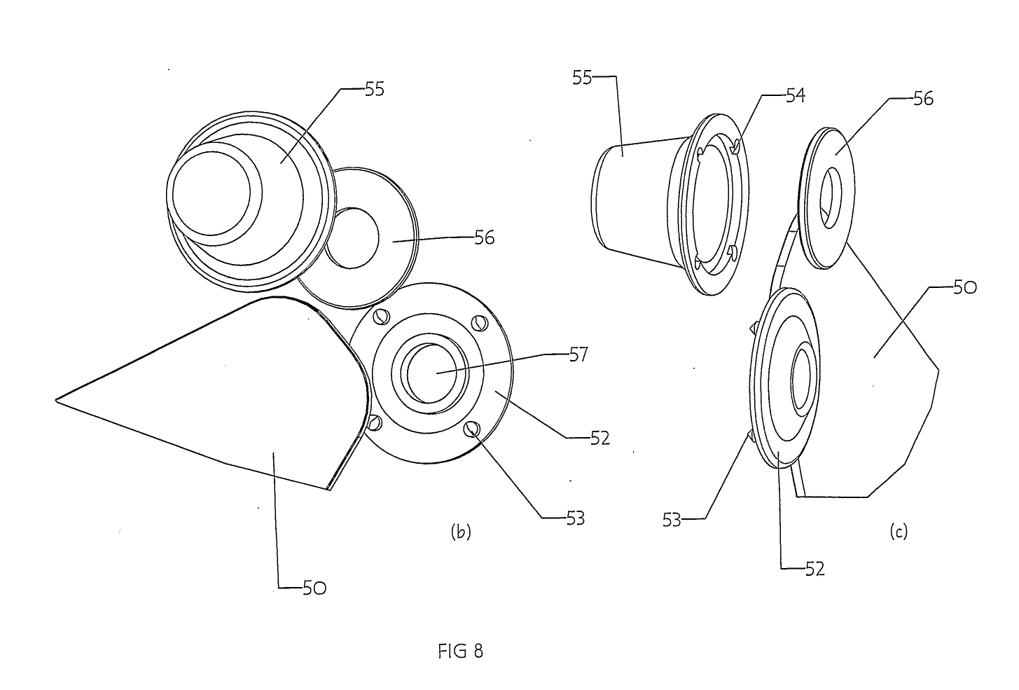

Referring now to FIG. 8, a flag or panel portion 50 of a suitable substantially flexible material is shown with a rigid portion 51 secured thereabout at one end. The rigid portion 51, forming in this instance a female member, has a flange member 52 with penetrating pegs or pins 53 which may pierce the material of portion 50 to be welded, or otherwise secured, into pockets or the like 54 in a cap 55 on the other side of the portion 50. A rigid washer spacer or insert 56 may be accommodated at the top of the cap 55 for the previously stated reason. An entry 57 through the flange 52 will receive the male tag (not shown). In this embodiment the material beneath the entry 57 is not broken until in use and by the male tag.

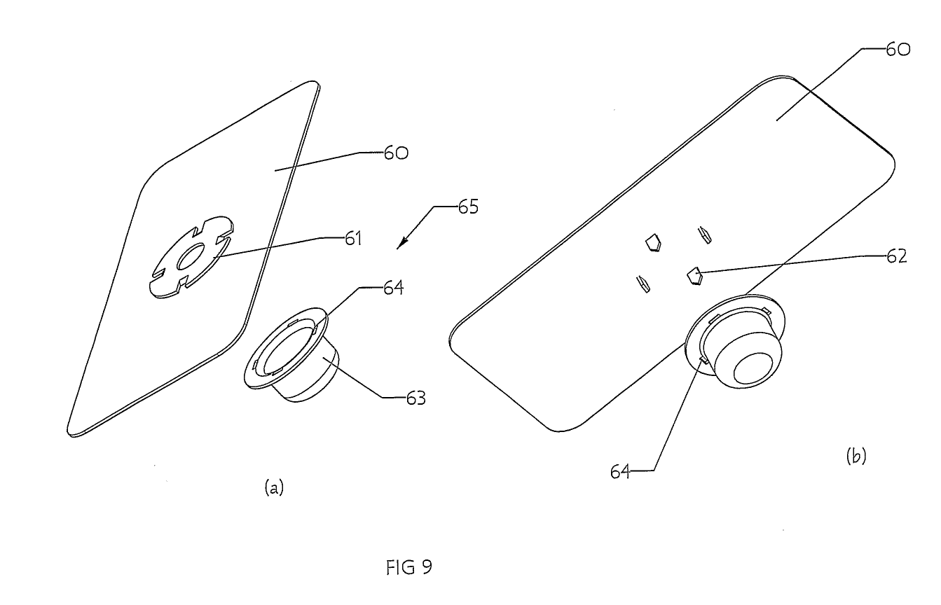

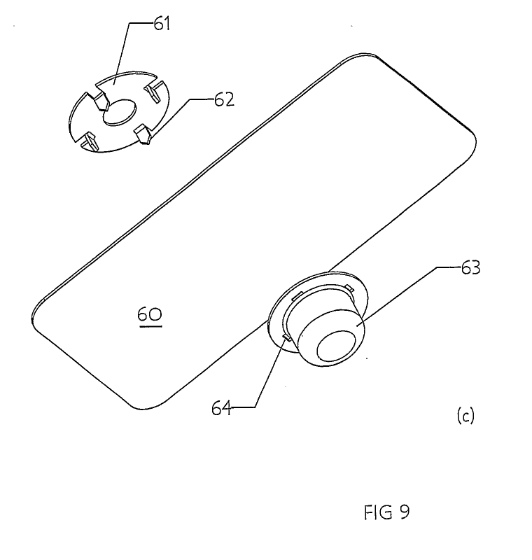

Referring now to FIG. 9, in a further possible embodiment a flag or label portion 60 of substantially flexible material has secured thereabout a rigid member in the form of a rivet or the like 65. This is shown with cap 63 with peripheral apertures 64 which can receive and secure spikes or teeth 62 of a flange member 61 which have pierced or penetrated the flexible material. The rivet 65 may be of any suitable material such as metal, plastics or the like.

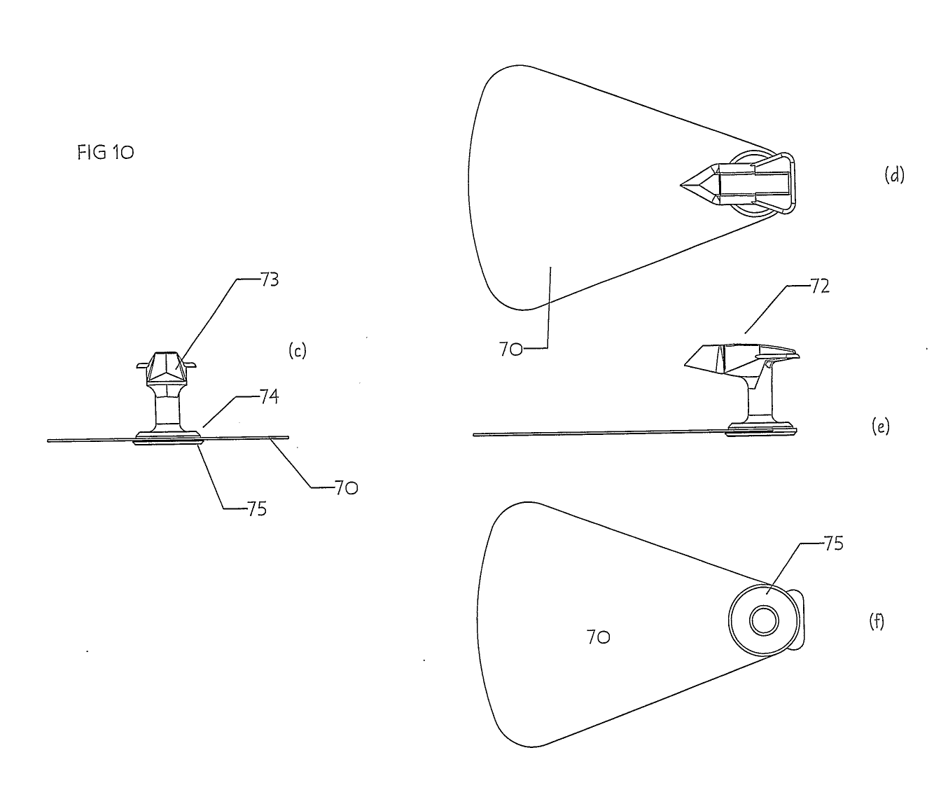

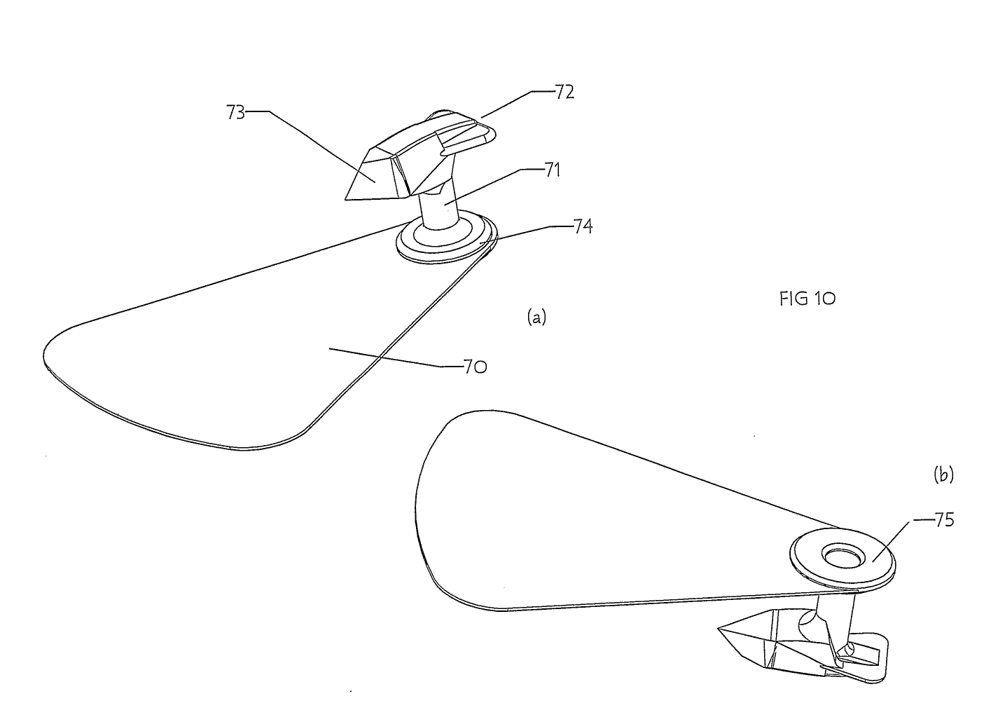

Referring now to FIG. 10, a one piece tag, such as that of the applicant's New Zealand patent no. 226296/228456, is shown with a substantially flexible flag portion 70 with an upstanding neck portion 71 extending to a head portion 72 with a cutting tip 73 to pierce the animal's ear. Flange portions 74 and 75 are shown permanently secured by any appropriate means on either side of the flag portion 70 so that the substantially rigid neck portion 71 is secured thereto. Of course the present invention could also be used with any of the other types of one piece tags, including those without cutting tips.

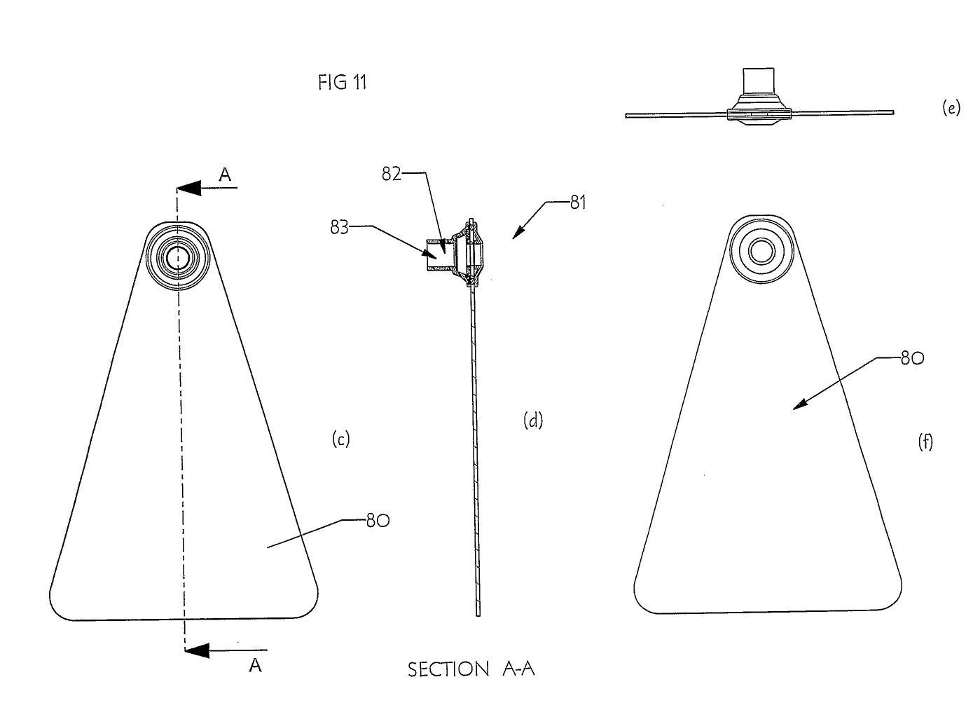

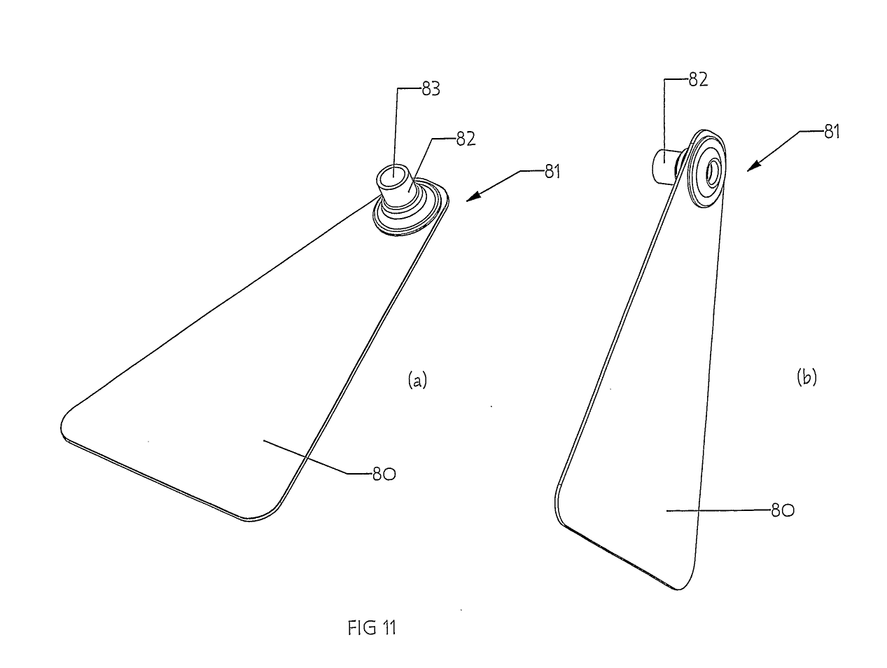

Referring then to FIG. 11, a flag portion 80 of a substantially flexible material is shown with a female substantially rigid portion 81 such as that described with reference to FIG. 2. However, it is seen that the female cone or cap 82 is in this embodiment open with an aperture 83. Such an open female cone or cap is able to be provided in that as it is part of a rigid portion 81 made separately from the flag 80, moulding limitations on providing an open cone may be avoided. Such an open cone or cap may be particularly useful in enabling biological samples to be taken by a punch or the like able to pass through the opening to be retrieved.

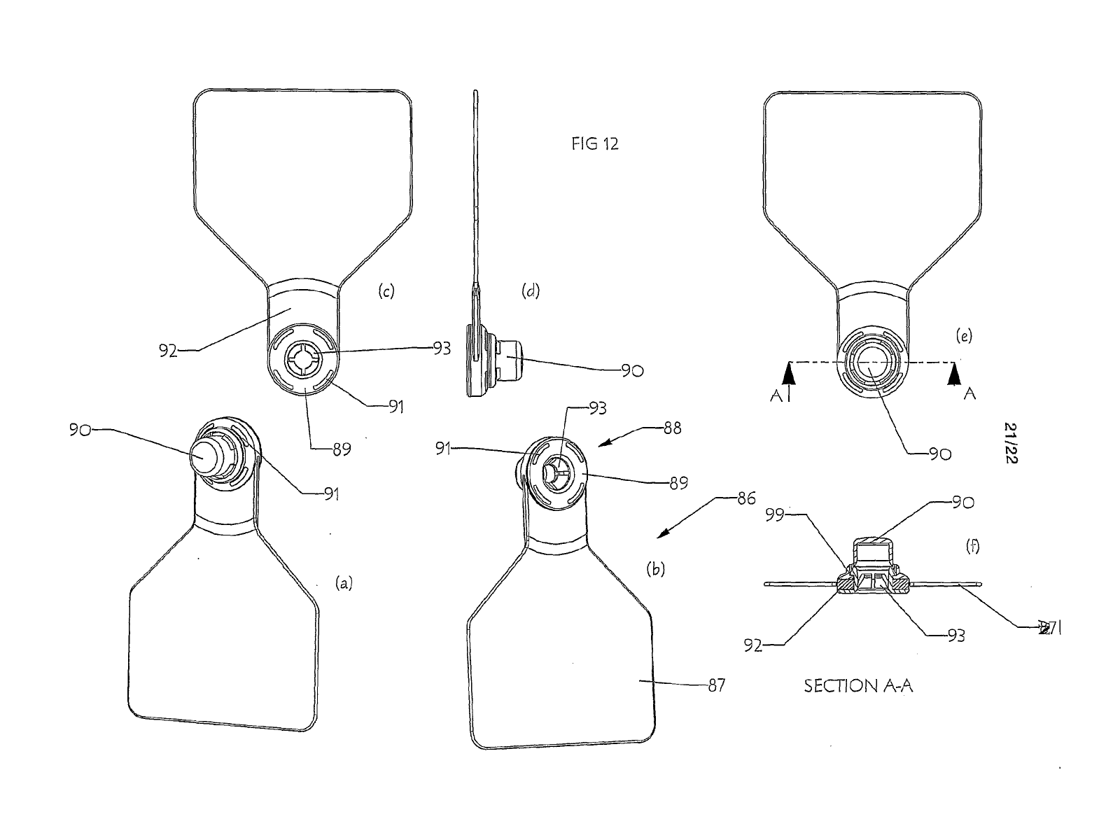

Referring then to FIG. 12, in this embodiment a tag, referenced generally by arrow 86, includes a flag portion 87 of a substantially flexible material and a substantially rigid portion referenced generally by arrow 88. The substantially rigid portion 88 includes a cap 90 on one side of the neck of the flag 87 and a flange member 89 on the other side. The components 90 and 89 will be assembled about the neck of the tag 87 and suitably the moulding operation will push the components together and the plastics material forming the flag 87 will, under pressure, flow through the holes in each of the components 89 and 90 to provide a “weld flow” of material. This is shown by reference 91 on both sides of the portion 88 as seen in FIGS. 12(a), (b) and (c). Particularly in FIG. 12 (f) the plastics material is shown forming the flag 87 in the neck portion with a thicker section of material, which will be sandwiched between the components 90 and 89. It will also be seen, particularly from FIGS. 12 (c) and (f), that the rigid component 89 may suitably be provided with a plurality of inwardly directed fingers 93 to assist in the retention of the head of the male tag (not shown). It is also seen particularly from FIG. 12 (f) that when the components 89 and 90 are pushed together they will engage in a snap-fit by means of respective engagement means 99 in the form of a lip provided on component 89 being able to engage with an inwardly facing ledge of cap 90.

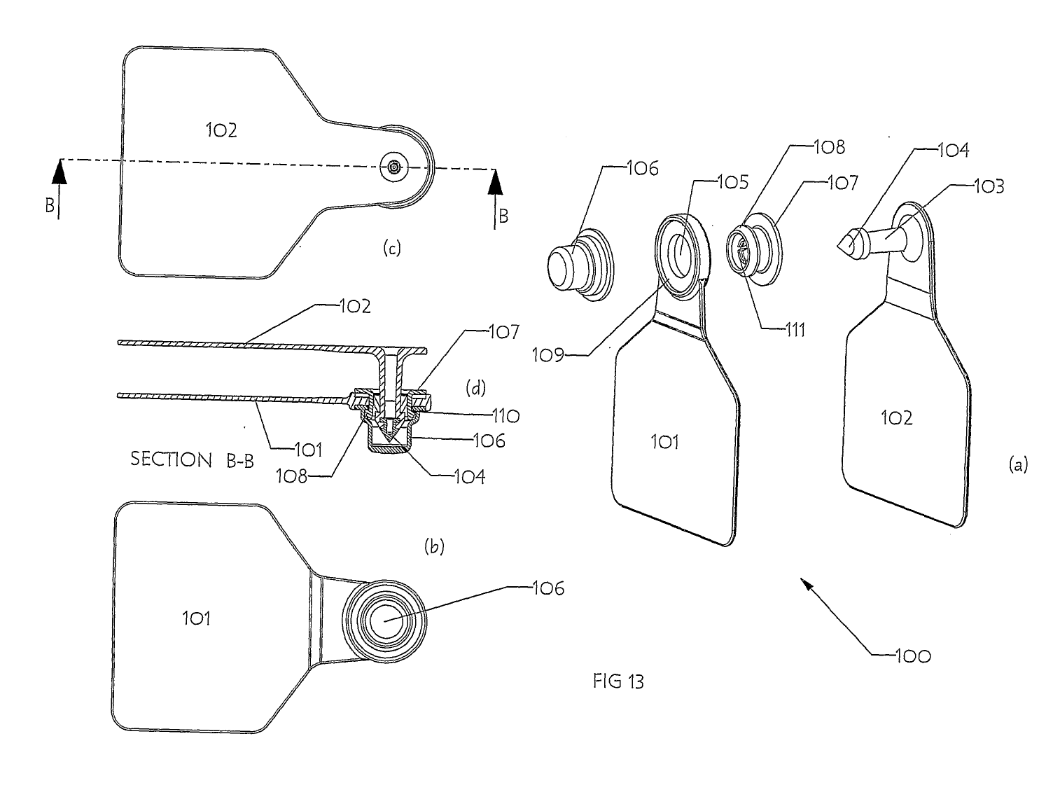

Turning then to FIG. 13, in a further embodiment of the invention a tag, referenced generally by arrow 100, is in the form of a two-piece tag assembly including a male tag having a substantially flexible flag 102 and a head portion 103 with a tip 104. The female tag includes a substantially flexible panel portion 101 and a substantially rigid portion including a cap member 106 which is engageable with a flanged member 107 as a push or press fit through the neck of the female flag member 101. An aperture 105 in the neck of the female member 101 has a recess 109 which is able to securely accommodate a ledge or rim 110 provided for the cap 106. As seen particularly in FIG. 13 (d) a projecting portion 108 at the outer end of member 107 is able to engage behind the ledge or rim 110. The member 107 may, as shown, be provided with a plurality of fingers 111 which will assist in the retention of the head 104 of the male tag.

It is seen therefore that the flag of a tag of a substantially flexible material may be simply and inexpensively formed, either individually or in strip form, and be integrated with a substantially rigid portion of the tag which has been secured thereabout. The materials used for the flexible and non-flexible portions of the tag do not mutually constrain the tag design which would otherwise result in the tooling being made prohibitively expensive because the rigid portion, forming the male or female tag portion, may not be secured, such as welded, to the flexible material, but instead is secured about it. In this way in some embodiments of this invention the materials used can be totally incompatible as they may be connected together by any appropriate means, such as by welding, riveting or moulding. The suitable materials, by example, may be flexible polyurethanes or similar for the substantially flexible material of the flags and softer parts, and nylon or acetal for the substantially rigid material of the caps and washers and inserts or alternatively any suitable metal such as brass or stainless steel.

It is even envisaged in one possible embodiment, see for example FIG. 9, that the rigid portion may be a simple rivet of metal or the like which may be secured in situ to a flag portion as the tag is applied to an animal.

It will be seen that the present invention removes the previous constraints imposed on the manufacture of tags, enabling “just-in-time” manufacture and avoiding the need for tags or tag components to be stock-piled or for tools to be changed in the moulding machine as different tags are to be manufactured.

Where in the foregoing description reference has been made to specific components or integers of the invention having known equivalents then such equivalents are herein incorporated as if individually set forth.

Although this invention has been described by way of example and with reference to possible embodiments thereof, it is to be understood that modifications or improvements may be made thereto without departing from the scope of the invention as defined in the appended claims.

1. An animal tag including a flag portion of a substantially flexible material wherein a substantially rigid portion has at least a first part and a second part, each part having respectively a first and a second aperture provided or providable therein, said parts being secured or securable together to be positioned on opposite sides of the flag portion to provide, in use, a female or male tag member.

2. An animal tag as claimed in claim 1 wherein the flag portion is provided as a strip of indeterminate length separable into a plurality of individual flag portions.

3. An animal tag as claimed in claim 1 or claim 2 wherein the rigid portion is secured about said flag portion by one of welding, over-moulding or riveting.

4. An animal tag as claimed in claim 1 wherein said substantially flexible material includes an aperture through which a portion of at least one of said first and second parts can be inserted to secure with the other of said parts.

5. An animal tag as claimed in any claim 1 wherein said first part includes a substantially hollow cap adapted to accommodate the head of a male tag.

6. An animal tag as claimed in claim 1 wherein said rigid portion has at least a third part which is substantially rigid and securable between said first part and said flexible material and adapted to assist in the retention of the head of the male tag.

7. An animal tag as claimed in claim 1 wherein said rigid portion includes an identification means.

8. An animal tag as claimed in claim 1 wherein said first part and said second part include respective first and second engagement means, the engagement means of said second part being adapted to pierce said substantially flexible material to engage with said engagement means of said first part.

9. An animal tag as claimed in claim 1 wherein said first part includes an opening at both of its ends to enable the retrieval from said first part of a sample taken from an animal.

10. An animal tag as claimed in claim 1 wherein at least one of said first and said second parts includes at least one further aperture through which said substantially flexible material can flow during the forming of said flag portion.

11. An animal tag as claimed in claim 1 wherein said substantially flexible material includes an aperture having a recess to accommodate a portion of said first part having a lip, said lip being engageable by a projecting portion provided on an outer end of said second part.

12. A method of manufacture of an animal tag having a flag portion of a substantially flexible material including providing a substantially rigid portion with at least a first part and a second part, securing said parts about the flag portion to be positioned on opposite sides of the flag portion to provide, in use, a female or male tag member, and providing each part respectively with a first and a second aperture before or after its securement with said flag portion.

13. A method of manufacture of an animal tag as claimed in claim 12 wherein the flag portion is first formed and said substantially rigid portion is then secured about said flag portion.

14. A method of manufacture of an animal tag as claimed in claim 12 wherein said substantially rigid portion is first positioned and said flag portion is then formed about said substantially rigid portion.

15. A method of manufacture of an animal tag as claimed in claim 14 wherein at least one of the parts of the rigid portion allows the flow there through of said flexible material as it forms into said flag portion.

16. A method of manufacture of an animal tag as claimed in claim 12 wherein said flag portion is provided as a strip of said substantially flexible material of indeterminate length which is separated into a plurality of individual flag portions after respective said substantially rigid portions have been secured about said individual flag portions.

17. (canceled)

18. (canceled)
